(19) United States
(12) Patent Application Publication
(10) Pub. No.: US 2009/0326082 A1
(43) Pub. Date: Dec. 31, 2009

(54) Compositions and Methods for Producing Articles from Recycled Materials

(76) Inventor: Jeffrey Jacob Cernohous, Hudson, WI (US)

Correspondence Address: Interfacial Solutions IP, LLC, 949 Antler Court, River Falls, WI, 54022, US

(21) Appl. No.: 12/438,988

(22) PCT Filed: Aug. 27, 2007
(86) PCT No.: PCT/US2007/018804

§ 371 Date: Feb. 26, 2009

Related U.S. Application Data
(60) Provisional application No. 60/840,666, filed on Aug. 28, 2006.

(51) Int. Cl. C08J 11/04; C08F 110/02; C08L 23/06; C08L 1/00

(52) U.S. Cl. 521/40; 526/352; 524/587; 524/35; 525/132

(57) ABSTRACT

The present invention relates to compositions and methods for producing articles from recycled materials. In one embodiment, a recycled polymeric matrix containing a super adsorbant polymer is thermally and/or chemically treated to produce a modified polymeric matrix. In a preferred embodiment, a modified polymeric matrix is subsequently melt processed with a filler. Articles produced from the modified polymeric matrix and the composites of this invention are useful as building materials, automotive components and consumer goods.

### CROSS REFERENCE TO RELATED APPLICATIONS

This patent claims priority U.S. Provisional Patent Application 60/840,666, herein incorporated by reference in its entirety.

### STATEMENT OF FEDERALLY FUNDED SPONSORED RESEARCH OR DEVELOPMENT

This invention was not supported by any federal funding.

### FIELD OF THE INVENTION

The present invention relates to compositions and methods for producing articles from recycled materials. Specifically, the present invention provides strategies for producing articles by melt processing polymeric waste streams that contain super absorbent polymers (SAP).

### BACKGROUND OF THE INVENTION

There are literally billions of pounds waste stream plastics today that contain SAP that could be utilized to produce for a variety of plastic and composite products. However, when such materials have attempted to be utilized in the past, the SAP present in the waste steam can be extremely problematic by blooming to the surface of the extrudate during processing and out of the plastic or composite product produced after a period of time. Additionally, articles produced from such waste materials will often uptake an undesirable amount of moisture when exposed to the environment. Therefore, there exists a need to selectively modify or remove the SAP present in such recycled polymeric materials to make them usable in plastic and composite articles.

### SUMMARY OF THE INVENTION

Specifically, the present invention contemplates a novel application of recycled materials containing SAP. According to the inventions SAP can be treated chemically, thermally or in combination such that the SAP is selectively deactivated or degraded in the recycled polymeric material. This invention contemplates that reactive additives can be utilized in this invention to modify that SAP polymer to increase its hydrophobicity. This invention also describes novel composite formulations that can be produced from the modified recycled polymeric material. In a preferred embodiment, the modified recycled polymeric material of this invention can be combined with fillers material to produce a composite article. Such composite articles have particular utility as building materials and automotive components.

In one embodiment, recycled polymeric materials are modified to selectively deactivate the SAP present in the material to produce a modified recycled polymeric material. In another embodiment, the modified recycled polymeric materials, hereafter referred to as modified polymeric matricies are combined with fillers to produce a composite. In this invention, composites are produced using melt processing techniques. In this invention, it is also feasible to add any melt processable polymer to the modified polymeric matrix to produce a polymer blend.

Materials and methods for producing filled composites, specifically wood filled composites are known. However, few if any, conventional strategies are disclosed that utilize modified polymeric matricies in melt processes as described herein. Additionally, the resulting filled composites of this invention are extremely low cost and have been found to have comparable mechanical properties when compared to composites known in the art. Thus, this invention provides a relatively simple strategy for producing filled composites that utilizes economically viable materials and methods.

For purposes of the present invention, the following terms used in this application are defined as follows:
“SAP” means a super absorbent polymer;
“Recycled Polymeric Material” means a melt processable polymeric material containing SAP that is derived from an article such as a baby diaper, feminine hygiene product or adult incontinence product;
“Modified Polymeric Matrix” means a recycled polymeric material that has been modified to deactivate, degrade or chemically transform a major portion of the SAP component within the recycled polymeric material;
“Melt Processable Composition” means a formulation that is melt processed, typically at elevated temperatures, by means of a conventional polymer processing technique such as extrusion or injection molding as an example;
“Filler” means an organic or inorganic material that does not possess viscoelastic characteristics under the conditions utilized to melt process the filled polymeric matrix;
“Cellulosic Material” means natural or man-made materials derived from cellulose. Cellulosic materials include for example: wood flour, wood fibers, sawdust, wood shavings, newsprint, paper, flax, hemp, grain hulls, kenaf, jute, sisal, nut shells or combinations thereof;
“Free Radical Producing Additive” means any material that at least partially decomposes into free radical containing moieties under melt processing conditions. Non-limiting examples include organic azo and peroxide compounds;
“Hydrophobic Additive” means an material that will chemically react with the SAP to make it less water absorbent; and
“Melt Processing Techniques” means extrusion, injection molding, blow molding, rotomolding batch mixing.

### DETAILED DESCRIPTION OF THE INVENTION

The present invention relates to compositions and methods for producing articles from recycled materials. Specifically, the present invention provides strategies for producing articles by melt processing polymeric waste streams that contain super absorbent polymers (SAP). Non-limiting examples of such recycled polymeric waste streams include baby diapers, feminine hygiene products and adult incontinence products. There are literally billions of pounds waste stream plastics today that contain SAP that could be utilized to produce for a variety of plastic and composite products. However, in the past, when such materials have been utilized, the SAP present in the waste steam is extremely problematic as it can bloom to the surface of the extrudate during processing. Additionally, blooming can also occur after processing in plastic or composite product produced after a period of time. This can lead to significant structural or aesthetic defects that are unacceptable in the final product. Therefore, there exists a need to selectively modify or remove the SAP present in such recycled polymeric materials to make them usable in plastic and composite articles.

This invention contemplates solutions to this problem. More specifically, recycled materials containing SAP can be melt processed under conditions such that the SAP is selectively deactivated or degraded in the recycled polymeric material. Chemical treatment, thermal treatment or combinations thereof may be utilized to modify the recycled polymer matrix. Chemical additives may be utilized in this invention to modify that SAP polymer to increase its hydrophobicity and/or modify its molecular weight. This invention also describes novel composite formulations that can be produced from the modified recycled polymeric material. In a preferred embodiment, the modified recycled polymeric material of this invention can be combined with fillers material to produce a composite article. Such composite articles have particular utility as building materials and automotive components.

The recycled polymeric materials of this invention are any that arise from articles that contain SAP. SAP is added to articles to provide moisture absorption characteristics. Conventional SAP compositions typically absorb as much as 100 times their weight in moisture. Thus the presence of active SAP compositions in the recycled polymeric material may adversely affect end use articles containing active SAP. Non-limiting examples of SAP materials include polymers that contain the monomers acrylic acid and its metal salts, methacrylic acid and its metal salts, and acrylamide. The recycled polymeric materials of this invention are typically produced from the scrap or waste articles that contain SAP. Non-limiting examples of such articles include baby diapers, feminine hygiene products and adult incontinence products. These articles typically are constructed of thermoplastic polymers, cellulosic fibers and SAP in varying ratios. In some cases, the resulting recycled polymeric material derived from these articles may contain as much as 30 wt % SAP. More typically, the SAP level in the recycled polymeric material is between 2 and 10 wt %.

Regarding the thermal treatment, the recycled polymeric material can be melt processed such that at least a majority of the SAP component is selectively deactivated to produce a modified polymeric material. In contemplation of the disclosure of the present invention, one skilled in the art is subsequently capable of determining the specific temperature settings and operating conditions required to selectively decompose or deactive a specific SAP component. In one strategy, the recycled polymeric material is processed at elevated melt temperatures for specified times to degrade the SAP. In doing so, the molecular weight of the crosslinked SAP particle may be modified to the point that it is no longer an insoluble gel when exposed to water. High shear melt processes such as twin screw extrusion and thermokinetic mixing are preferred for carrying out this modification. Preferably, the recycled polymeric material is melt processed at temperatures between 220 and 320° C., more preferably between 240 and 300° C., and most preferably between 260 and 300° C.

Regarding the chemical treatment, the recycled polymeric material can be treated with a reactive species to deactivate at least a major portion of the SAP component in the recycled polymeric material. One type of reactive species is a free radical producing additive. Free radical producing additives can be added to the formulation to promote a molecular weight change of the SAP. Non-limiting examples of free radical producing additives include azo compounds and organic peroxides. Hydrophilic azo compounds and organic peroxides are preferred free radical producing additives. The free radical producing additive is utilized at levels between 0.05 wt % to 10 wt %.

In another embodiment, hydrophobic additives can be added to the formulation as a form of chemical treatment. Hydrophobic additives function by modifying the SAP to make it less hydrophilic. It is preferable that the hydrophobic additive can chemically react with the pendant metal carboxylate salts present in the SAP. Non-limiting examples of hydrophobic additives useful for this invention include: epoxidized soy and linseed oils, phenol-formaldehyde resins, urea-formaldehyde resins, maleated soy and linseed oils, blown soy and linseed oils, functionalized polyolefins and reactive silicone and fluoropolymers. The hydrophobic additives of this invention are preferably utilized at levels between 0.05 wt % and 50 wt %, more preferably between 0.1 wt % and 20 wt % and most preferably between 0.5 wt % and 10 wt %.

In an alternate embodiment, combinations of chemical and thermal treatment are utilized to deactivate or degrade the SAP component of the recycled polymeric material. In yet another alternative embodiment, the chemical and/or thermal treatment of SAP in recycled polymeric materials may be accomplished while forming an end use article.

Upon or during processing of the recycled polymeric material, a wide variety of conventional polymers are suitable for blending to form the modified polymeric matrix of this invention using conventional melt processing techniques. They include both hydrocarbon and non-hydrocarbon polymers. Examples of useful polymers include, but are not limited to, polyamides, polyimides, polyurethanes, polyolefins, polystyrenes, polyesters, polycarbonates, polyketones, polyureas, polyvinyl resins, polyacrylates and polymethylacrylates.

Preferred polymers for blending include, high density polyethylene (HDPE), low density polyethylene (LDPE), linear low density polyethylene (LLDPE), polypropylene (PP), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyacrylates, polymethacrylates, polyesters, polyvinylchloride (PVC), fluoropolymers, polyamides, polyether imides, polyphenylene sulfides, polysulfones, polyacetals, polycarbonates, polyphenylene oxides, polyurethanes, thermoplastic elastomers (e.g., SIS, SEBS, SBS), epoxies, alkyds, melamines, phenolics, ureas, vinyl esters or combinations thereof. Most preferred polymeric matrices are polyolefins and thermoplastic elastomers.

In another aspect of the invention, the modified polymer matrix can be melt processed with additional fillers. Non-limiting examples of fillers include mineral and organic fillers (e.g., talc, mica, clay, silica, alumina, carbon fiber, carbon black glass fiber) and conventional cellulosic materials (e.g., wood flour, wood fibers, sawdust, wood shavings, newsprint, paper, flax, hemp, wheat straw, rice hulls, kenaf, jute, sisal, peanut shells, soy hulls, or any cellulose containing material). The amount of filler in the melt processable composition may vary depending upon the polymeric matrix and the desired physical properties of the finished composition. Those skilled in the art of melt processing polymers are capable of selecting appropriate amounts and types of fillers to match with a specific polymeric matrix in order to achieve desired physical properties of the finished material.

The amount of the filler in the melt processable composition may vary depending upon the polymeric matrix and the desired physical properties of the finished composition. Those skilled in the art of melt processing polymers are capable of selecting an appropriate amount and type of filler(s) to match with a specific polymeric matrix in order to achieve desired physical properties of the finished material. Typically, the filler may be incorporated into the melt processable composition in amounts up to about 90% by weight. Preferably, the filler is added to the melt processable composite composition at levels between 5 and 90%, more preferably between 15 and 80% and most preferably between 25 and 70% by weight of the formulation. Additionally, the filler may be provided in various forms depending on the specific polymeric matrices and end use applications. Non-limiting examples of filler form include, powder and pellets.

Cellulosic materials are commonly utilized in melt processable compositions as fillers to impart specific physical characteristics or to reduce cost of the finished composition. Cellulosic materials generally include natural or wood based materials having various aspect ratios, chemical compositions, densities, and physical characteristics. Non-limiting examples of cellulosic materials include wood flour, wood fibers, sawdust, wood shavings, newsprint, paper, flax, hemp, rice hulls, kenaf, jute, sisal, peanut shells. Combinations of cellulosic materials and a modified polymer matrix may also be used in the melt processable composition.

In another aspect of the invention, the melt processable composition may contain other additives. Non-limiting examples of conventional additives include antioxidants, light stabilizers, fibers, blowing agents, foaming additives, antiblocking agents, heat stabilizers, impact modifiers, biocides, compatibilizers, flame retardants, plasticizers, tackifiers, colorants, processing aids, lubricants, coupling agents, and pigments. The additives may be incorporated into the melt processable composition in the form of powders, pellets, granules, or in any other extrudable form. The amount and type of conventional additives in the melt processable composition may vary depending upon the polymeric matrix and the desired physical properties of the finished composition. Those skilled in the art of melt processing are capable of selecting appropriate amounts and types of additives to match with a specific polymeric matrix in order to achieve desired physical properties of the finished material.

The present invention also contemplates methods for melt processing the novel compositions. Non-limiting examples of melt processes amenable to this invention include methods such as extrusion, injection molding, blow molding, rotomolding and batch mixing.

The melt processable composition of the invention can be prepared by any of a variety of ways. For example, the modified polymeric matrix and the filler can be combined together by any of the blending means usually employed in the plastics industry, such as with a compounding mill, a Banbury mixer, or a mixing. The filler and the modified polymeric matrix may be used in the form, for example, of a powder, a pellet, or a granular product. The mixing operation is most conveniently carried out at a temperature above the melting point or softening point of the processing additive, though it is also feasible to dry-blend the components in the solid state as particulates and then cause uniform distribution of the components by feeding the dry blend to a twin-screw melt extruder. The resulting melt-blended mixture can be either extruded directly into the form of the final product shape or pelletized or otherwise comminuted into a desired particulate size or size distribution and fed to an extruder, which typically will be a single-screw extruder, that melt-processes the blended mixture to form the final product shape.

Melt-processing typically is performed at a temperature from 120° to 300° C., although optimum operating temperatures are selected depending upon the melting point, melt viscosity, and thermal stability of the composition. Different types of melt processing equipment, such as extruders, may be used to process the melt processable compositions of this invention. Extruders suitable for use with the present invention are described, for example, by Rauwendaal, C., “Polymer Extrusion,” Hansen Publishers, p. 11-33, 2001.

### EXAMPLES

### Materials

| MATERIAL | DESCRIPTION |
|---|---|
| HDPE | P4G4Z-011 0.8 MFI high density polyethylene |
| | commercially supplied by Huntsman (Salt Lake |
| | City, UT) |
| Wood Fiber | Wood Fiber, 40 mesh hardwood fiber commercially |
| | available from American Wood Fibers (Schofield, WI) |
| Recycled | Densified diaper material commercially available from |
| Polymer | Georgia Industrial Polymers (Social Circle, GA). |
| Phenolic | StructurFast OS-518SA, commercially available from |
| Resin | Hexion Chemical Corporation (Columbus, OH) |

Preparation of Modified Recycled Polymers 1-4.

Composite samples were prepared and testing using the following protocol. To produce modified recycled polymer 1 the following procedure was utilized. The recycled polymer was gravity fed into a 27 mm co-rotating twin screw extruder fitted with three strand die (commercial available from American Leistritz Extruder Corporation, Sommerville, N.J.). All samples were processed at 150 rpm screw speed using the following temperature profile: Zone 1-2=200° C., Zone 3-4=220° C., Zone 5-6=260° C., Zone 7-8=280° C. The resulting strands were subsequently cooled in a water bath and pelletized into ˜¼″ pellets to produce the modified recycled polymer.

To produce modified recycled polymers 2-4 identical conditions were utilized with the following modification. The recycled polymer was first treated with a specified amount of phenolic resin (Structurfast OS-518SA, commercially available from Hexion Specialty Chemical Corporation) by spraying the phenolic resin onto the recycled polymer and dry blending the material in a bag. This material was subsequently melt processed under identical conditions to modified recycled polymer 1. Table 1 provides the formulations that were utilized to prepare modified recycled polymers 1-4.

TABLE 1
Experimental Formulations for Modified Recycled Polymers 1-4

| Modified | | Phenolic |
|---|---|---|
| Recycled Polymer | Recycled Polymer | Resin wt % |
| 1 | 100 | 0 |
| 2 | 99 | 1 |
| 3 | 97.5 | 2.5 |
| 4 | 95 | 5 |

Preparation and Characterization of Comparative Examples CE1-CE6 and Examples 1-12

The resulting pellets and the wood were predried for 4 hours at 200° F. in a Conair resin drying unit. Resin (HDPE or the modified recycled polymer), and the wood fiber was then dry mixed in a plastic bag and gravity fed into a 27 mm co-rotating twin screw extruder fitted with three strand die (commercial available from American Leistritz Extruder Corporation, Sommerville, N.J.). All samples were processed at 150 rpm screw speed using the following temperature profile: Zone 1-2=150° C., Zone 3-4=160° C., Zone 5-6=180° C., Zone 7-8=190° C. The resulting strands were subsequently cooled in a water bath and pelletized into ˜¼″ pellets. The resulting pellets were injection molded into test specimens following ASTM D638 (tensile) and D790 (flexural) specifications. Injection molding on composite formulations was performed using a 85 ton machine (commercially available from Engel Corporation, York, Pa.) having a barrel and nozzle temperature of 390° F. to produce specimens for tensile, flexural and moisture testing. The flexural and tensile properties were subsequently tested as specified in the ASTM methods. The injection molded test specimens were also submerged in water for 2 hours and subsequently visually inspected for the presence of SAP gel on the surface of the specimen. Table 2 gives the formulations that were produced following this procedure. Table 3 gives the gel present after water submersion and Table 4 gives the mechanical properties of these composite formulations.

TABLE 2
Fomulations for Comparative Examples CE1-CE6 and Examples 1-12

| | | Recycled | Modified | Modified | |
|---|---|---|---|---|---|
| | HDPE | Polymer | Recycled | Recycled | Wood |
| Example | (wt %) | (wt %) | Polymer | Polymer wt % | (wt %) |
| CE1 | 60 | — | | — | 40 |
| CE2 | 50 | — | | — | 50 |
| CE3 | 40 | — | | — | 60 |
| CE4 | — | 60 | | — | 40 |
| CE5 | — | 50 | | — | 50 |
| CE6 | — | 40 | | — | 60 |
| 1 | — | — | 1 | 60 | 40 |
| 2 | — | — | 1 | 50 | 50 |
| 3 | — | — | 1 | 40 | 60 |
| 4 | — | — | 2 | 60 | 40 |
| 5 | — | — | 2 | 50 | 50 |
| 6 | — | — | 2 | 40 | 60 |
| 7 | — | — | 3 | 60 | 40 |
| 8 | — | — | 3 | 50 | 50 |
| 9 | — | — | 3 | 40 | 60 |
| 10 | — | — | 4 | 60 | 40 |
| 11 | — | — | 4 | 50 | 50 |
| 12 | — | — | 4 | 40 | 60 |

TABLE 3
SAP Gel Formation for Comparative
Examples CE1-CE6 and Examples 1-12

| | Gel Present after |
|---|---|
| Example | Water Submersion |
| CE1 | No |
| CE2 | No |
| CE3 | No |
| CE4 | Yes |
| CE5 | Yes |
| CE6 | Yes |
| 1 | No |
| 2 | No |
| 3 | No |
| 4 | No |
| 5 | No |
| 6 | No |
| 7 | No |
| 8 | No |
| 9 | No |
| 10 | No |
| 11 | No |
| 12 | No |

TABLE 4
Tensile and Flexural Properties for Comparative
Examples CE1-CE3 and Examples 1-12

| | Tensile | Tensile | Elongation | Flexural | |
|---|---|---|---|---|---|
| | Strength | Modulus | At Break | Modulus | Density |
| Example | (MPa) | (MPa) | (%) | (MPa) | (g/cm³) |
| CE1 | 23.6 | 4045 | 3.4 | 2930 | 1.04 |
| CE2 | 23.7 | 4789 | 1.7 | 3246 | 1.06 |
| CE3 | 22.2 | 5725 | 0.9 | 3750 | 1.08 |
| 1 | 14.4 | 4696 | 1.2 | 3596 | 0.80 |
| 2 | 14.5 | 5842 | 1.1 | 3447 | 0.81 |
| 3 | 14.0 | 4785 | 1.1 | 3428 | 0.82 |
| 4 | 17.6 | 4123 | 1.2 | 3596 | 0.79 |
| 5 | 16.3 | 4362 | 1.1 | 3692 | 0.82 |
| 6 | 15.7 | 4950 | 1.1 | 3856 | 0.85 |
| 7 | 18.6 | 4865 | 1.2 | 3752 | 0.77 |
| 8 | 17.2 | 5103 | 1.1 | 3926 | 0.81 |
| 9 | 16.9 | 5562 | 1.1 | 4023 | 0.82 |
| 10 | 19.4 | 5001 | 1.2 | 4003 | 0.75 |
| 11 | 18.6 | 5866 | 1.1 | 4069 | 0.82 |
| 12 | 17.9 | 6235 | 1.1 | 4255 | 0.82 |

From the above disclosure of the general principles of the present invention and the preceding detailed description, those skilled in this art will readily comprehend the various modifications to which the present invention is susceptible. Therefore, the scope of the invention should be limited only by the following claims and equivalents thereof.

1. A composition of matter comprising a modified polymeric matrix.

2. The composition according to claim 1 further comprising a filler.

3. The composition according to claim 2 wherein the filler is a cellulosic material.

4. The composition according to claim 2 wherein the modified polymer matrix is produced by thermal treatment, chemical treatment or a combination thereof.

5. The composition according to claim 4 wherein the chemical treatment is accomplished by using a hydrophobic additive, free radical producing additive or combinations thereof.

6. The composition according to claim 1 further comprising at least one melt processable polymeric material.

7. The composition according to claim 1 wherein the modified polymeric matrix has a moisture uptake of less than 5 wt % after 24 hour submersion at 25° C.

8. The composition according to claim 2 where that exhibits a flexural modulus of at least 3000 MPa according to ASTM method D790.

9. The composition according to claim 2 where the density is less than 1.00 g/cm³.

10. A method comprising treating a recycled polymeric material by thermal treatment, chemical treatment or combinations thereof to form a modified polymeric matrix.

11. The method according to claim 10 wherein the treating is carried out using melt processing techniques.

12. The method according to claim 10 wherein the chemical treatment is accomplished by using a hydrophobic additive, free radical producing additive or combinations thereof.

13. The method according to claim 10 wherein the treating the recycled polymeric material is carried out using high shear melt processing equipment.

14. The method according to claim 11 wherein at least one filler is additionally incorporated.

15. The method according to claim 11 further comprising at least one melt processable polymeric material.

16. An article comprising the composition of claim 1.

17. An article according to claim 16 wherein the article is a building product, an automotive component or a consumer good.
